(19) United States
(12) Patent Application Publication
(10) Pub. No.: US 2006/0244934 A1
(43) Pub. Date: Nov. 2, 2006

(54) Paper processing apparatus and paper processing method

(75) Inventor: Kazuhisa Yoshida, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/372,181

(22) Filed: Mar. 10, 2006

(30) Foreign Application Priority Data
Mar. 18, 2005 (JP) 2005-080458
Feb. 16, 2006 (JP) 2006-039353

(51) Int. Cl. G03B 27/00

(52) U.S. Cl. 355/1

(57) ABSTRACT

In a paper processing apparatus which processes paper, information including a characteristic amount is detected by a sensor section from paper to be processed, a processing program is selectively loaded into an internal memory of a high-speed CPU every processing program unit from an external memory storing various processing programs including a plurality of instructions to obtain information used to process the paper from the information detected by the sensor section, the processing program selectively loaded in the internal memory every processing program unit is executed by CPU core of the high-speed CPU, and the paper is processed on the basis of processing results of the processing program.

### CROSS-REFERENCE TO RELATED APPLICATIONS

This application is based upon and claims the benefit of priority from prior Japanese Patent Applications No. 2005-080458, filed Mar. 18, 2005; and No. 2006-039353, filed Feb. 16, 2006, the entire contents of both of which are incorporated herein by reference.

### BACKGROUND OF THE INVENTION

1. Field of the Invention

The present invention relates to a paper processing apparatus and a paper processing method which detect information including a characteristic amount from paper, inspect the paper on the basis of the detected information, and process the paper in accordance with the result of the inspection.

2. Description of the Related Art

A paper processing apparatus and a paper processing method have heretofore been in practical use which detect information including a characteristic amount such as image data from paper by a sensor, inspect the paper on the basis of the information detected by the sensor, and process the paper in accordance with the result of the inspection.

The paper processing apparatus as described above is provided with an inspection section which obtains information to process the paper from the information detected by the sensor. In such an inspection section, a CPU executes a processing program prestored in, for example, a memory in order to process the information detected by the sensor. Further, in the paper processing apparatus, a plurality of processing programs is stored in the memory to judge a plurality of kinds of characteristics and to perform processing including a plurality of stages.

However, the plurality of processing programs used in the paper processing apparatus has a large amount of data as a whole. Therefore, those processing programs are stored in a memory provided outside the CPU which actually executes the processing. In such a configuration, the CPU which actually executes the processing usually executes data (one instruction in the processing program) loaded into an internal memory for one instruction unit constituting each processing program. As a result, it takes a long time even for a CPU capable of high-speed processing to execute the processing programs stored in the external memory. In addition, in the paper processing apparatus as described above, the speed of processing by the inspection section influences processing efficiency of the entire apparatus. Therefore, the entire paper processing apparatus has a problem of the processing efficiency that decreases as the processing programs become complicated.

### BRIEF SUMMARY OF THE INVENTION

One mode of this invention is directed to provide a paper processing apparatus and a paper processing method capable of restraining efficiency of processing paper from decreasing.

A paper processing apparatus as one mode of this invention comprises: a sensor which detects information including a characteristic amount of paper to be processed; a external memory which stores various processing programs including a plurality of instructions to process the information detected by the sensor; a first processor which selectively loads the various processing programs stored in the external memory every processing program unit; a second processor which executes the processing program selectively loaded into a second memory by the first processor; and a processing section which processes the paper on the basis of processing results of the processing program executed by the second processor.

A paper processing apparatus as one mode of this invention comprises: a conveyance section which conveys paper; a sensor which detects information including a characteristic amount from the paper conveyed by the conveyance section; an inspection section which inspects the paper on the basis of the information detected by the sensor; and a sort processing section which sorts the paper conveyed by the conveyance section in accordance with an inspection result by the inspection section, wherein the inspection section has: a external memory which stores various processing programs including a plurality of instructions to obtain the inspection result used for sorting the paper on the basis of the information detected by the sensor; a first processor which selectively loads the various processing programs stored in the external memory every processing program unit; and a second processor which executes the processing program selectively loaded into a second memory by the first processor.

A paper processing method as one mode of this invention comprises: detecting information including a characteristic amount from paper to be processed; selectively loading a processing program every processing program unit from a external memory storing various processing programs including a plurality of instructions to obtain information to process the paper from the information including the characteristic amount detected from the paper to be processed; executing the processing program selectively loaded into a internal memory; and processing the paper on the basis of processing results of the processing program.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a schematic configuration of a paper processing apparatus according to a first embodiment;

FIG. 2 is a diagram showing a configuration example of an inspection processing section of the paper processing apparatus;

FIG. 3 is a diagram showing a configuration example of sensor data distributed from a distributor;

FIG. 4 is a diagram showing a configuration example of an inspection processor;

FIG. 5 is a diagram showing a configuration example of the inside of an internal RAM in a high-speed CPU;

FIG. 6 is a flowchart to explain an operation example of the inspection processor;

FIG. 7 is a flowchart to explain shape detection processing as an example of processing executed by one processing program;

FIG. 8 is a flowchart to explain denomination detection processing as an example of processing executed by one processing program;

FIG. 9 is a flowchart to explain magnetism detection processing as an example of processing executed by one processing program;

FIG. 10 is a diagram showing a schematic configuration of a mail sorting apparatus according to a second embodiment;

FIG. 11 is a diagram showing a configuration example of a control system of the mail sorting apparatus;

FIG. 12 is a diagram showing a configuration example of a discrimination section in an address reading section; and

FIG. 13 is a flowchart to explain an operation example of the discrimination section.

### DETAILED DESCRIPTION OF THE INVENTION

Embodiments of this invention will hereinafter be described with reference to the drawings.

A first embodiment will first be explained.

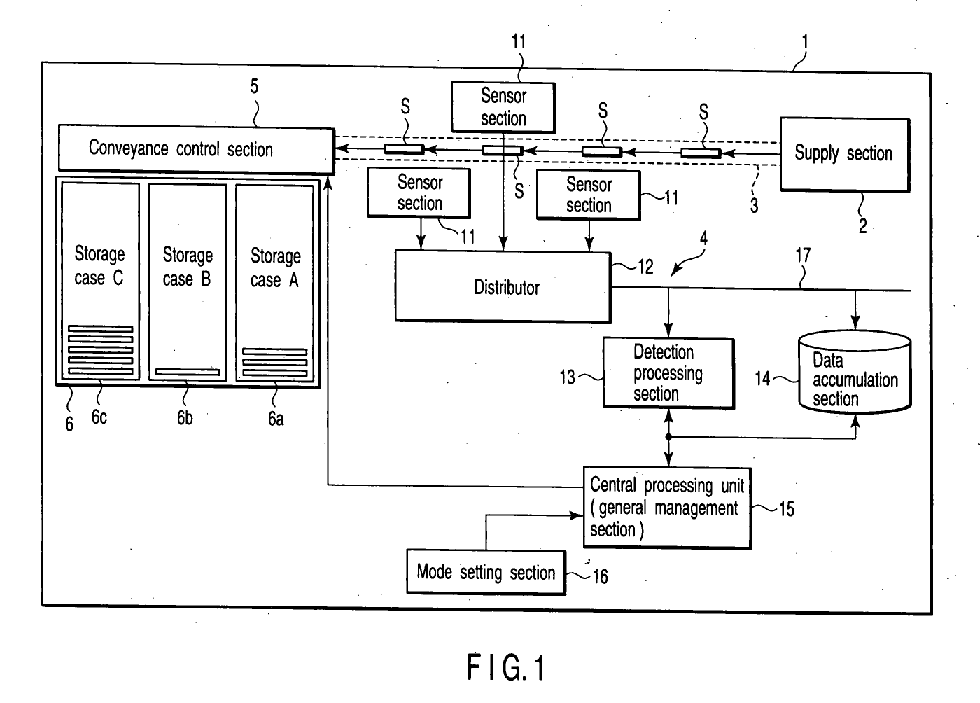

FIG. 1 is a diagram showing a schematic configuration of a detection target processing apparatus (paper processing apparatus) which processes a detection target (paper) S.

A processing apparatus 1 of the detection target comprises a supply section 2, a conveyance path 3, an inspection device 4, a conveyance control section 5, an accumulation section 6, etc. Moreover, the inspection device 4 comprises a plurality of sensor sections 11, a distributor 12, an inspection processing section 13, a data accumulation section 14, a general management section 15, a mode setting section 16, etc.

The paper S as the detection target is set in the supply section 2. The supply section 2 supplies the paper S as the detection target to the conveyance path 3 one by one. The conveyance path 3 individually conveys the paper S supplied from the supply section 2.

The inspection device 4 inspects the paper S conveyed on the conveyance path 3. The inspection device 4 detects various physical properties (characteristic amounts) of the paper S to inspect, for example, the state of the paper S. Further, the inspection device 4 judges a conveyance destination (accumulation destination) and the like of each piece of paper S on the basis of an inspection result of the paper S.

The conveyance control section 5 controls the conveyance of each piece of paper S on the basis of the result of an inspection by the inspection device 4. The conveyance control section 5 controls the driving of, for example, an not shown gate to perform the conveyance control so that paper S may be accumulated in the accumulation destination based on the result of the inspection by the inspection device 4.

The accumulation section 6 comprises a plurality of storage cases 6a, . . . . The kind, state or the like of the accumulating paper S is set in the storage cases 6a, . . . . Therefore, in the storage cases 6a, . . . , the paper S is accumulated which has been sorted on the basis of the kind, state or the like of the paper as the result of the inspection by the inspection device 4.

Next, a configuration example of the inspection device 4 will be schematically explained.

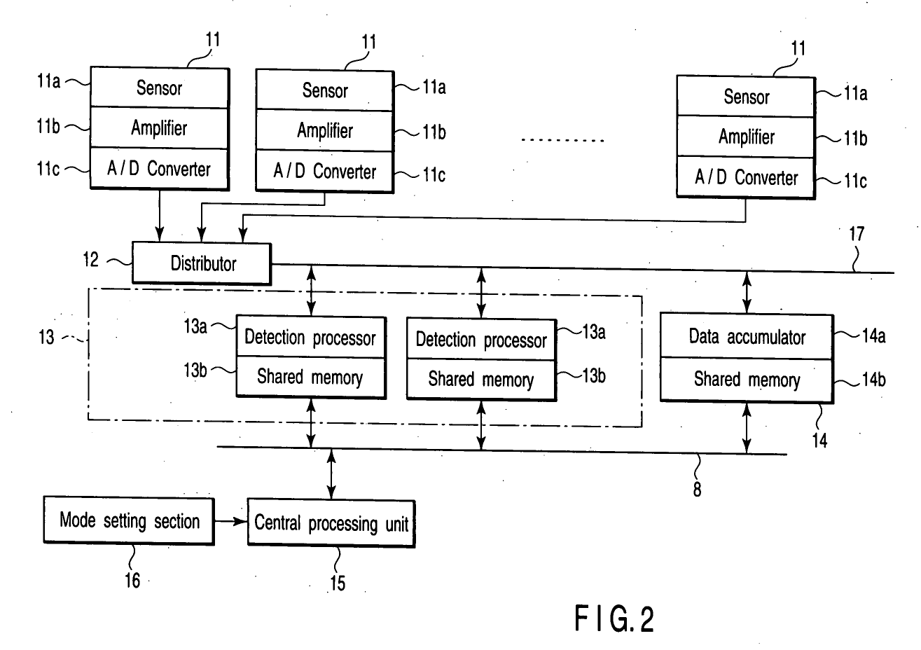

FIG. 2 is a diagram showing the configuration example of the inspection device 4.

As shown in FIGS. 1 and 2, the inspection device 4 comprises the plurality of sensor sections 11, the distributor 12, the inspection processing section 13, the data accumulation section 14, the central processing unit (general management section) 15, the mode setting section 16, etc.

Each of the sensor sections 11 detects as electric signals various physical properties from the paper S conveyed by the conveyance path. For example, for the sensor section 11, use is made of a scanner (sensor which detects a surface image, shape or conveyance state of a ticket) which optically reads image data on the surface of the paper S with a visible light, a magnetism detection sensor (sensor which detects magnetism) which detects magnetic information included in the paper S, an infrared sensor (sensor which detects a special ink) which optically reads, with infrared rays, image data formed by a special ink on the surface of the paper S, or a thickness detection sensor which detects the thickness of the paper S.

Furthermore, as shown in FIG. 2, each of the sensor sections 11 comprises a sensor 11a, an amplifier 11b, an A/D converter 11c, etc. The sensor 11a detects the electric signals indicating the various physical properties from the paper S conveyed by the conveyance path 3. The amplifier 11b amplifies the electric signals detected by the sensor 11a. The A/D converter 11c converts the analog electric signal detected by the sensor 11a and amplified by the amplifier 11b into a digital electric signal.

The distributor 12 outputs a detection signal by each of the sensor sections 11 to the inspection processing section 13. The distributor 12 distributes the electric signal detected by each of the sensor sections 11 to a plurality of detection processors 13a in the inspection processing section 13 described later. It is to be noted that the distributor 12 is connected to the detection processors 13a and the data accumulation section 14 by a data bus 17.

The distributor 12 assigns identification information to the detection signals from the respective sensor sections 11, . . . supplied asynchronously and in parallel. The distributor 12 replaces, with serial output data, the detection signals to which the identification information has been assigned. The distributor 12 outputs the data replaced with the serial output data to each of the detection processors 13a. Moreover, the distributor 12 carries out the replacement using a horizontal synchronization signal and a reference clock supplied from the general management section (central processing unit) 15.

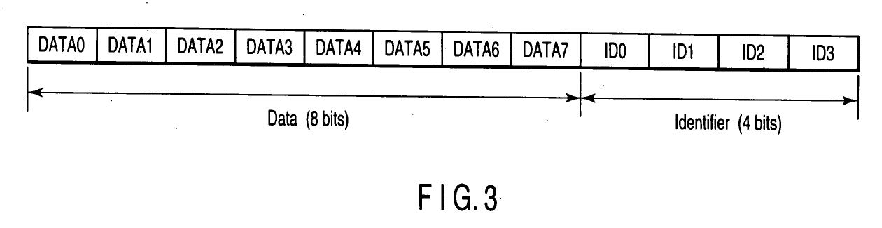

FIG. 3 is a diagram showing a configuration example of data output from the distributor 12 to each of the detection processors 13a. It is to be noted that the width of the data output from the distributor 12 to each of the detection processors 13a is set in accordance with a bit width of the data bus 17. In the example shown in FIG. 3, the data output from the distributor 12 to each of the detection processors 13a has 12 bits. Moreover, in the example shown in FIG. 3, the data output from the distributor 12 to each of the detection processors 13a is constituted of 8-bit data as a substantial part of the detection signal detected by each of the sensor sections 11, and 4-bit identification information (identifier) corresponding to the 8-bit data.

The identification information is the information to identify the paper S or the sensor section 11. The identification information is given by, for example, the central processing unit 15. Further, as the identification information, a serial number is assigned to each piece of paper S sequentially conveyed on the conveyance path 3 in such a manner as to define ‘0’ as a start time of the paper processing apparatus. Such identification information is used to identify, for example, the paper or the sensors.

The distributor 12 assigns identification information to the electric signals indicating the various physical properties digitized by the sensor sections 11 to distribute them to the plurality of detection processors 13a in the inspection processing section. The distributor 12 also supplies the signal from the sensor sections 11 to which the identification information has been assigned, to the data accumulation section 14 as well as to the detection processors 13a. Thus, in the data accumulation section 14, the information is accumulated which has been detected by the sensor sections 11 and to which the identification information has been assigned.

As shown in FIG. 2, the inspection processing section 13 comprises a plurality of detection processors 13a and shared memories 13b, etc. Each of the shared memories 13b corresponds to each of the detection processors 13a. Each unit constituted of the detection processor 13a and the shared memory 13b functions as a processing section which processes the electric signal detected by the sensor sections 11. The respective shared memories 13b corresponding to the respective detection processors 13a are connected via a data bus 18. Moreover, each of the shared memories 13b is also connected to the data accumulation section 14 and the central processing unit 15 via the data bus 18.

Each of the detection processor 13a processes, by a configuration as described later, the electric signal detected by each of the sensor sections 11. The shared memories 13b function as interfaces of the detection processors 13a. Each of the detection processor 13a assigns the identification information for the information to be processed (information detected by the sensor sections) to processed information (inspection processing result), and supplies it to the central processing unit (general management section) 15 via the shared memory 13b. Further, each of the detection processor 13a also supplies, to the data accumulation section 14, the inspection processing result to which the identification information has been assigned. Therefore, the information (the inspection processing result to which the identification information has been assigned) processed by each of the detection processors 13 is accumulated in the data accumulation section 14.

The data accumulation section 14 comprises a data accumulator 14a and a shared memory 14b. The data accumulator 14a comprises a storage device to store data. Moreover, the shared memory 14b functions as an interface to input/output data. As described above, in the data accumulation section 14, there are stored the information (the information which has been detected by the sensor sections 11 and to which the identification information has been assigned) supplied from the distributor 12, and the information (the information on the inspection processing result to which the identification information has been assigned) processed in each of the detection processors 13a. Therefore, the information detected by the sensor and accumulated in the data accumulator 14a (the information detected by the sensor sections and the inspection processing result) can be searched for using the identification information as a key.

The central processing unit 15 collects the information processed by each of the detection processors 13a from each of the shared memories 13b, and determines an overall inspection result regarding the paper S. Moreover, the central processing unit 15 informs the conveyance control section 5 of, for example, a place (storage case 6a, . . . ) where each piece of paper S is to be conveyed, on the basis of the result of inspecting each piece of paper S and an operation mode set by the mode setting section 16.

The mode setting section 16 sets the operation mode of the paper processing apparatus in accordance with an instruction from an operator or the like. Further, the mode setting section 16 sets, as the operation mode, the kind, state or the like of the paper S to be accumulated in the storage cases 6a . . . . In addition, the mode setting section 16 may set, as the operation mode, the conveyance state of the paper S (skew, short pitch, slide, etc.), the kind of paper S (denomination), or the state of the paper (correct ticket, loss ticket, rejected ticket) so that it serves as a standard by which the mode setting section 16 makes judgments.

Furthermore, the inspection device 4 structured as described above determines the inspection result regarding the paper S within a predetermined period of time. For example, the inspection device 4 is set to determine the inspection result within a time before the paper S conveyed on the conveyance path 3 is separated into the storage cases 6a, . . . . That is, the inspection device 4 obtains an inspection result within a conveyance time (limitation of detection processing time) in which each piece of paper S passes the sensor sections 11, . . . and reaches a separation gate to each of the storage cases 6a, . . . .

Next, a configuration example of each of the detection processors 13a will be described in detail.

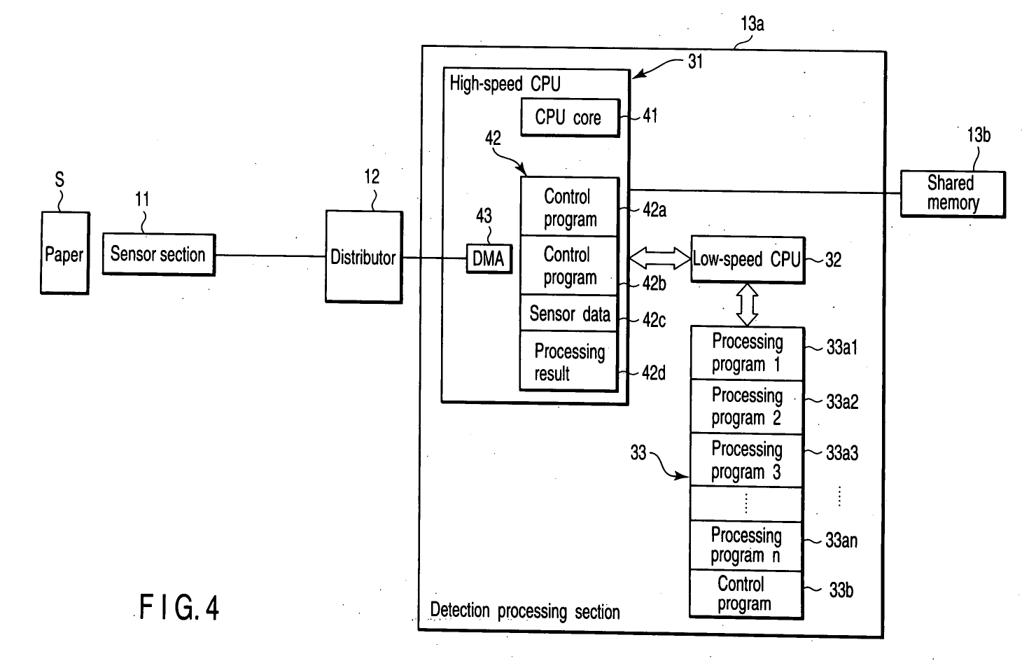

FIG. 4 is a diagram showing the configuration example of each of the detection processors 13a.

As shown in FIG. 4, each of the detection processors 13a has a high-speed CPU 31, a low-speed CPU 32, an external ROM 33, etc.

The high-speed CPU 31 comprises a CPU core 41, an internal RAM 42, a direct memory access (DMA) 43, etc. The CPU core 41 is a processor which performs operation processing. The CPU core 41 performs the operation processing for the data stored in the internal RAM 42 on the basis of a program loaded into the internal RAM 42. Moreover, the CPU core 41 stores the results of the operation processing into the internal RAM 42.

The internal RAM 42 stores a program to be executed by the CPU core 41, and data. The internal RAM 42 is a memory which allows high-speed access by the CPU core 41. As shown in FIG. 4, the internal RAM 42 has a control program storage area 42a, a processing program storage area 42b, a sensor data storage area 42c, a processing result storage area 42d, etc. These storage areas will be described later in detail.

The low-speed CPU 32 operates in response to a request from the high-speed CPU 31. The low-speed CPU 32 controls access to the external ROM 33. The low-speed CPU 32 reads a processing program stored in the external ROM 33 on the basis of a processing program download request (request to rewrite the processing program) from the high-speed CPU 31, and outputs it to the high-speed CPU 31.

The external ROM 33 stores a control program, various processing programs and the like to be downloaded to the high-speed CPU 31. In the configuration example shown in FIG. 4, the external ROM 33 has storage areas 33a1, 33a2, . . . , 33an to store the various processing programs, and a storage area 33b to store the control program. The processing programs stored in the storage areas 33a1, 33a2, . . . , 33an are programs which perform processing to obtain a particular inspection result on the basis of the sensor data. For example, the processing program stored in the storage area 33a1, 33a2, . . . , 33an includes a processing program for processing program shape detection processing, a processing program for denomination detection processing, or a processing program for magnetism detection processing. Here, an algorithm including various instructions to perform processing for the acquisition of the particular inspection result is called the processing program.

Next, a configuration example of the inside of the internal RAM 42 will be described.

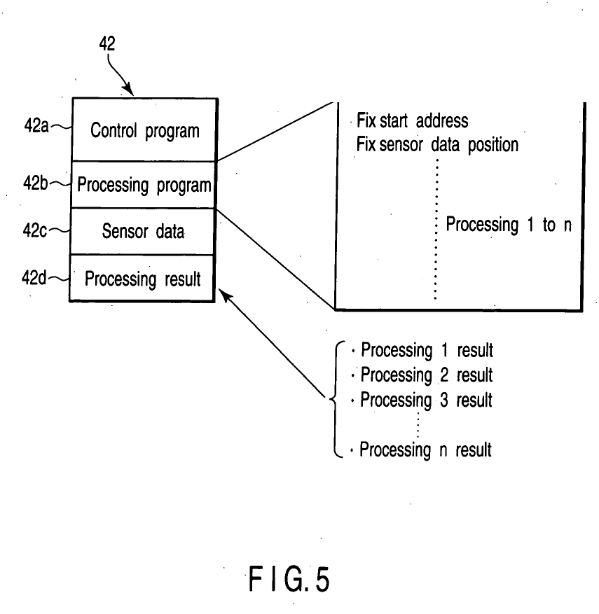

FIG. 5 is a diagram showing the configuration example of the inside of the internal RAM.

As shown in FIG. 5, the internal RAM 42 has the control program storage area 42a, the processing program storage area 42b, the sensor data storage area 42c, the processing result storage area 42d, etc.

The control program storage area 42a is a storage area where the control program is loaded. The control program loaded into the control program storage area 42a controls the basic operation of the detection processors 13a. That is, in each of the detection processors 13a, the CPU core 41 executes the control program stored in the control program storage area 42a to achieve processing by the various processing programs as described later.

The processing program storage area 42b is a storage area where the various processing programs are loaded. In the present paper processing apparatus, the various processing programs are sequentially loaded into the processing program storage area 42b every processing program unit. Further, the processing program stored in the processing program storage area 42b is a program to process information (sensor data) detected by the sensor sections 11 to be stored in the sensor data storage area 42c. Still further, in the above-mentioned processing program, a processing result in the preliminary processing stored in the processing result storage area 42d is used to execute processing.

The sensor data storage area 42c is a storage area where the information (sensor data) detected by the sensor sections 11 is stored. The processing result storage area 42d is a storage area where the processing results are stored. That is, data as the processing results made by the various processing programs used in a series of processing are accumulated in the processing result storage area 42d. Moreover, a start address in the internal RAM 42 is fixed for the processing program storage area 42b. A storage position in the internal RAM 42 is fixed for the sensor data storage area 42c.

Next, an operation example of the detection processors 13a structured as described above will be described.

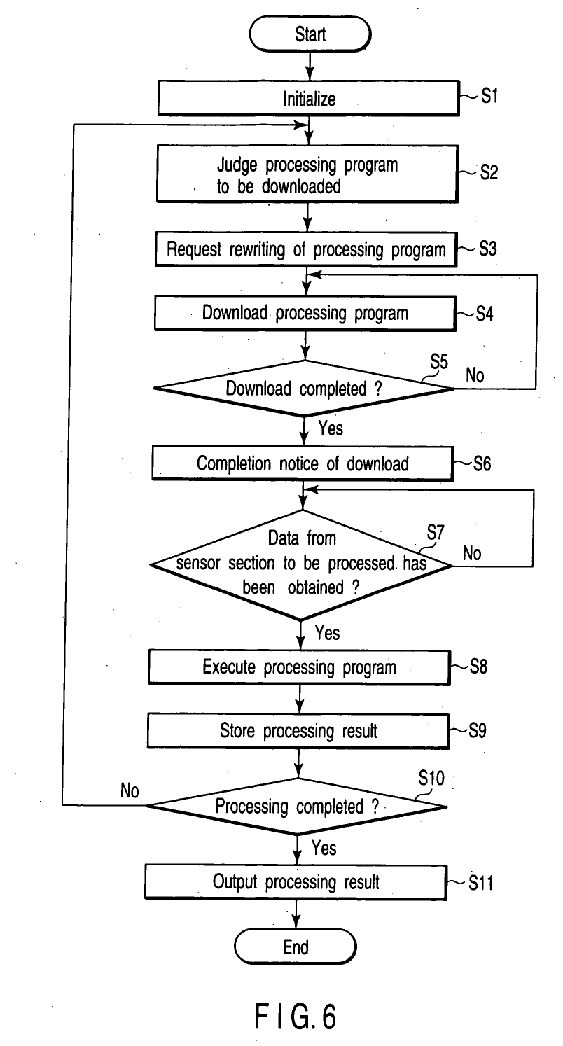

FIG. 6 is a flowchart to explain an operation example of the detection processors 13a. Here, each of the detection processors 13a outputs the detection result for one piece of paper. In this processing, each of the detection processors 13a executes processing for various data detected from particular paper by the respective sensor sections 11 . . . to output various characteristics of the particular paper to the central processing unit 15 as inspection results. In this case, the information (sensor data) detected by each of the sensor sections 11 from the particular paper identified by the identification information from the distributor 12 is distributed to each of the detection processors 13a. It is to be noted that information detected by the particular sensor section 11 may be distributed in each of the detection processors 13a. In this form of processing, each of the detection processors 13a executes processing for data detected by the particular sensor section to output a particular characteristic of each piece of paper as an inspection result to the central processing unit 15.

Here, any one of the detection processors 13a executes inspection processing for the particular paper. In addition, various data detected by the respective sensor sections 11 . . . from the particular paper have been supplied to the detection processor 13a, and stored in the sensor data storage area 42c of the internal RAM 42.

First, the CPU core 41 of the high-speed CPU 31 performs processing to initialize the inside of the high-speed CPU 31 on the basis of the control program stored in the control program storage area 42a of the internal RAM 42 (step S1). In connection with this, the CPU core 41 of the high-speed CPU 31 judges a processing program to be downloaded to the processing program storage area 42b of the internal RAM 42 on the basis of the above-mentioned control program (step S2). This is achieved to judge each program including at least a plurality of instruction units as a processing program to be downloaded. Here, one processing program to be downloaded is judged every processing program unit corresponding to each process.

However, when one processing program corresponding to one process has a data size that can not be contained in the processing program storage area 42b of the internal RAM 42, the CPU core 41 may judge each program divided from one processing program corresponding to one process as a processing program to be downloaded in one download process. Moreover, when a plurality of processing programs corresponding to a plurality of processes has a data size that can be contained in the processing program storage area 42b of the internal RAM 42, the CPU core 41 may judge the plurality of processing programs corresponding to the plurality of processes as processing programs to be downloaded in one download process.

When a processing program to be downloaded is determined in the judgment, the CPU core 41 of the high-speed CPU 31 outputs a download request to request the download of the processing program (request for the rewriting of the processing program) to the low-speed CPU 32 (step 3).

The low-speed CPU 32 which has received such a download request executes processing to download the processing program (processing to transfer the processing program) corresponding to the request from the high-speed CPU 31. That is, the low-speed CPU 32 which has received the download request selectively reads the processing program that is requested by the high-speed CPU 31 to be downloaded out of the processing programs stored in the external ROM 33. Once the low-speed CPU 32 reads the processing program, it downloads the processing program into the high-speed CPU 31.

When the requested download of the processing program is started by the low-speed CPU 32, the high-speed CPU 31 stores the transferred (downloaded) processing program into the processing program storage area 42b of the internal RAM 42 (step S4). At this moment, data (executed processing programs) stored in the processing program storage area 42b of the internal RAM 42 are erased. That is, in step S4, the processing programs stored in the processing program storage area 42b of the internal RAM 42 are rewritten.

When the whole processing program downloaded by the low-speed CPU 32 is stored in the processing program storage area 42b of the internal RAM 42, that is, when the download of the processing program from the low-speed CPU 32 is completed (step S5, YES), the CPU core 41 of the high-speed CPU 31 outputs to the low-speed CPU 32 a download completion notice indicating that the download is completed (step S6).

Furthermore, when the download of the processing program is completed, the CPU core 41 of the high-speed CPU 31 judges whether or not the sensor data to be processed has been obtained (step S7). This judgment is made to see whether or not at least the data from the sensor sections 11 to be processed by the downloaded processing program is stored in the sensor data storage area 42c of the internal RAM 42. It is to be noted that each of the detection processors 13a here performs processing for the various data detected from the particular paper by the respective sensor sections 11 . . . . Therefore, it may be judged whether or not the various data detected from the particular paper by the respective sensor sections 11 . . . are stored in the sensor data storage area 42c of the internal RAM 42.

When the above judgment is that the sensor data to be processed has been obtained (step S7, YES), the CPU core 41 of the high-speed CPU 31 performs the processing program stored in the processing program storage area 42b of the internal RAM 42 to process the data stored in the sensor data storage area 42c of the internal RAM 42 (step S8). Moreover, the CPU core 41 of the high-speed CPU 31 stores the result (processing result) of executing the processing program stored in the processing program storage area 42b of the internal RAM 42 into the processing result storage area 42d of the internal RAM 42 (step S9).

When the processing performed with the processing program stored in the processing program storage area 42b of the internal RAM 42 is completed, the CPU core 41 of the high-speed CPU 31 judges whether or not the whole series of processing (the processing by all the processing programs to be executed) has been completed (step S10). This judgment is made to see whether or not the processing by all the processing programs to be executed has been completed for the sensor data stored in the sensor data storage area 42c of the internal RAM 42. In other words, the above judgment is made to see whether or not there exists a processing program to be subsequently executed.

When the above judgment is that the whole series of processing has been completed (step S10, YES), the CPU core 41 of the high-speed CPU 31 outputs, to the central processing unit 15 via the shared memories 13b, information in which the identification information is assigned to the processing result stored in the processing result storage area 42d of the internal RAM 42. Further, the information in which the identification information is assigned to the processing result stored in the processing result storage area 42d of the internal RAM 42 is also supplied to the data accumulation section 14 via the shared memories 13b.

It is to be noted that the respective detection processors 13a here process various kinds of information detected by the various sensor sections 11 from one piece of paper. Thus, if the whole series of processing for the sensor data stored in the sensor data storage area 42c of the internal RAM 42 is completed (step S10, YES), the processing result stored in the processing result storage area 42d of the internal RAM 42 is an inspection result for the paper specified by the identification information. Therefore, in step S11, the inspection result for the paper specified by the identification information is supplied to the central processing unit 15 and the data accumulation section 14 from the detection processors 13a via the shared memories 13b.

Furthermore, if the above judgment is that the whole series of processing is not completed, that is, if the above judgment is that there exists a processing program to be subsequently executed (step S10, NO), the CPU core 41 of the high-speed CPU 31 returns to step S2, and again performs the processing of steps S2 to S10. In this case, the high-speed CPU 31 rewrites the processing program stored in the processing program storage area 42b of the internal RAM 42 to the next processing program, and performs the processing in accordance with the next processing program.

Next, examples of processing executed by the respective processing programs will be described.

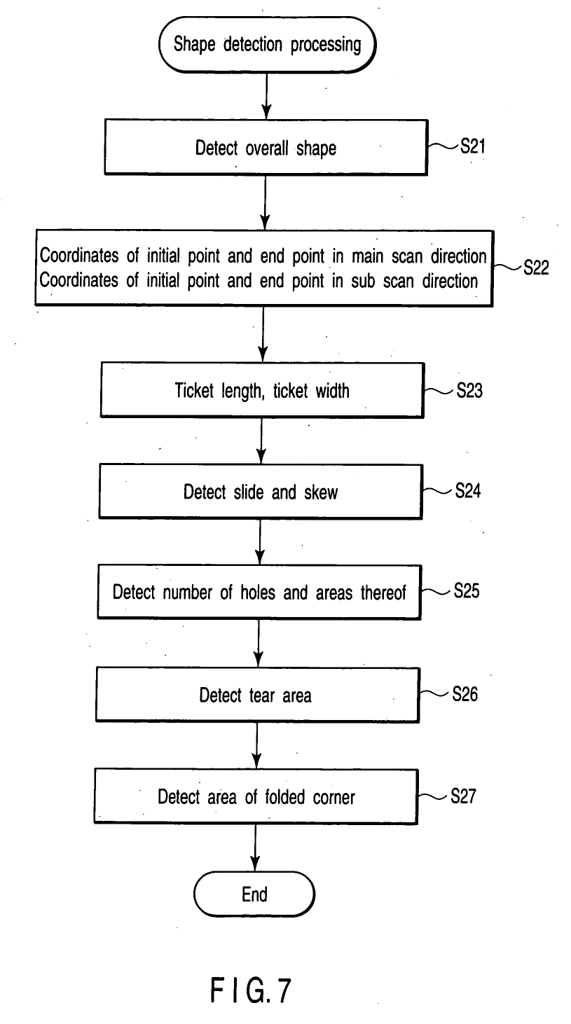

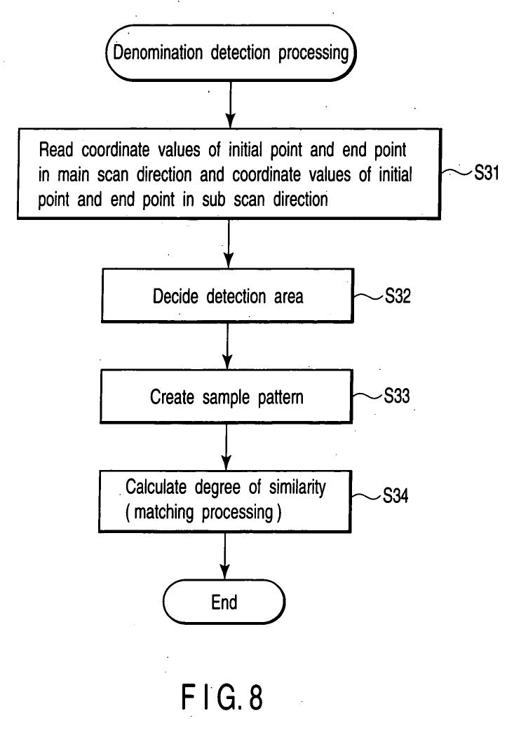

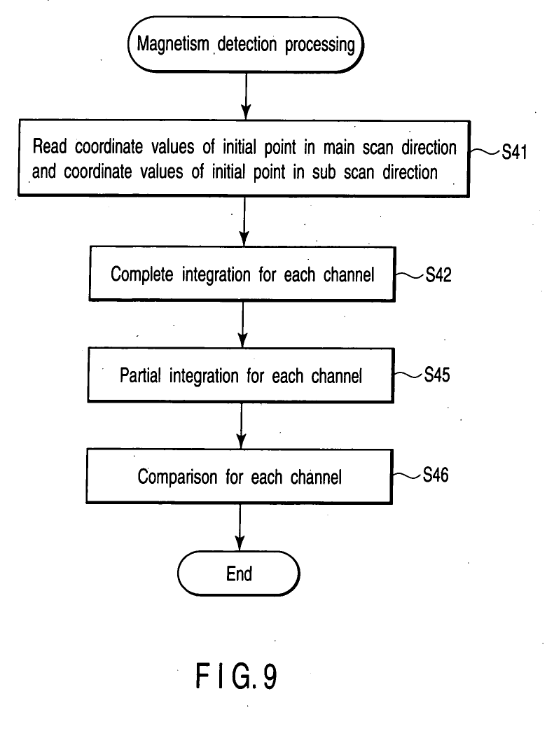

FIGS. 7, 8 and 9 are flowcharts to explain the examples of processing executed by the respective processing programs. FIG. 7 is a flowchart to explain shape detection processing as one example of processing executed by one processing program. FIG. 8 is a flowchart to explain denomination detection processing as an example of processing executed by one processing program. FIG. 9 is a flowchart to explain magnetism detection processing as an example of processing executed by one processing program. In addition, it is assumed that the shape detection processing, the denomination detection processing and the magnetism detection processing are executed in this order.

First, the shape detection processing will be described.

The shape detection processing is executed on the basis of image data obtained by optically reading an image on paper. Therefore, one of the sensor sections 11 comprises a scanner which optically reads the image on the paper. In addition, the scanner as the sensor section 11 includes a CCD line sensor. The scanner as the sensor section 11 is disposed so that the CCD line sensor reads a main scan direction of the paper conveyed on the conveyance path 3. Thus, in the image data read by the scanner as the sensor section 11, the direction perpendicular to the conveyance direction of the paper is defined as the main scan direction while the conveyance direction of the paper is defined as a sub scan direction.

Furthermore, the image on the paper read by the scanner as the sensor section 11 (image data) is stored in the sensor data storage area 42c of the internal RAM 42 in the detection processor 13a. Moreover, a processing program (processing program for the shape detection processing) to execute the shape detection processing described later has been loaded in the processing program storage area 42b of the internal RAM 42.

In this state, as shown in FIG. 7, the CPU core 41 of the high-speed CPU 31 in the detection processor 13a first performs overall shape detection processing to detect the overall shape of the paper, in accordance with the processing program for the shape detection processing stored in the processing program storage area 42b of the internal RAM 42 (step S21). In this overall shape detection processing, a region in which there seems to be the paper is detected in the image data read by the scanner as the sensor section 11. As the result of this detection, information is obtained which indicates the shape of the whole paper in the image data. Here, it is assumed that the paper has a rectangular shape. In this case, the information indicating the shape of the whole paper is represented by coordinate values of an initial point and an end point in the main scan direction and coordinate values of an initial point and an end point in the sub scan direction in the image data. That is, as the result of the overall shape detection processing, the coordinate values of the initial point and end point in the main scan direction and the coordinate values of the initial point and end point in the sub scan direction are stored as a detection result (processing result) in the processing result storage area 42d of the internal RAM 42.

When the overall shape detection processing is completed, the CPU core 41 of the high-speed CPU 31 performs processing to read the coordinate values of the initial point and end point in the main scan direction and the coordinate values of the initial point and end point in the sub scan direction that have been obtained as the processing results of the overall shape detection processing (step S22).

When the CPU core 41 of the high-speed CPU 31 has read the coordinate values of the initial point and end point in the main scan direction and the coordinate values of the initial point and end point in the sub scan direction in the image data (processing results of the overall shape detection processing), it performs size detection processing to judge the size of the paper in a longitudinal direction and the size of the paper in a width direction, in accordance with the processing program for the shape detection processing (step S23). This size detection processing is executed on the basis of the coordinate values of the initial point and end point in the main scan direction and the coordinate values of the initial point and end point in the sub scan direction as the detection results of the overall shape. Moreover, results of this size detection processing are stored in the processing result storage area 42d of the internal RAM 42.

Following the size detection processing, the CPU core 41 of the high-speed CPU 31 performs conveyance state detection processing to detect the slide and skew (inclination) of the paper with respect to the conveyance direction, in accordance with the processing program for the shape detection processing (step S24). This conveyance state detection processing is executed on the basis of the coordinate values of the initial point and end point in the main scan direction and the coordinate values of the initial point and end point in the sub scan direction as the detection results of the overall shape. Moreover, results of this conveyance state detection processing are also stored in the processing result storage area 42d of the internal RAM 42.

Following the conveyance state detection processing, the CPU core 41 of the high-speed CPU 31 performs hole detection processing to detect the number of holes and areas thereof in the paper, in accordance with the processing program for the shape detection processing (step S25). This hole detection processing is executed in such a manner as to detect all the holes in the paper in a region defined by the coordinate values of the initial point and end point in the main scan direction and the coordinate values of the initial point and end point in the sub scan direction as the detection results of the overall shape, and calculate the areas of the holes. Moreover, results of this hole detection processing are also stored in the processing result storage area 42d of the internal RAM 42.

Following the hole detection processing, the CPU core 41 of the high-speed CPU 31 performs tear detection processing to detect a tear area in the paper, in accordance with the processing program for the shape detection processing (step S26). This tear detection processing is executed in such a manner as to detect tear regions in the paper in the region defined by the coordinate values of the initial point and end point in the main scan direction and the coordinate values of the initial point and end point in the sub scan direction as the detection results of the overall shape, and calculate the areas of the tear regions. Moreover, results of this tear detection processing are also stored in the processing result storage area 42d of the internal RAM 42.

Following the tear detection processing, the CPU core 41 of the high-speed CPU 31 performs fold detection processing to detect a fold area in the paper, in accordance with the processing program for the shape detection processing (step S24). This fold detection processing is executed in such a manner as to detect fold regions in the paper in the region defined by the coordinate values of the initial point and end point in the main scan direction and the coordinate values of the initial point and end point in the sub scan direction as the detection results of the overall shape, and calculate the areas of the fold regions. Moreover, results of this fold detection processing are also stored in the processing result storage area 42d of the internal RAM 42.

In the shape detection processing achieved by one processing program as described above, the overall shape, size, conveyance state, holes, tear, fold, etc. are detected as the detection results regarding one piece of paper, and these results are stored in the processing result storage area 42d of the internal RAM 42.

Next, the denomination detection processing will be described.

The denomination detection processing is executed on the basis of the image data obtained by optically reading an image on paper. In addition, the denomination detection processing is executed after the shape detection processing. Therefore, when the denomination detection processing is executed, the processing results of the shape detection processing have been stored in the processing result storage area 42d of the internal RAM 42. Thus, the processing program to achieve the denomination detection processing is programmed to properly refer to the processing results of the shape detection processing.

Furthermore, in the following explanation, the image (image data) on the paper read by the scanner as the sensor section 11 has been stored in the sensor data storage area 42c of the internal RAM 42 in the detection processor 13a. Moreover, one processing program (processing program for the denomination detection processing) to execute the denomination detection processing described later has been loaded into the processing program storage area 42b of the internal RAM 42. Here, it is assumed that the denomination detection processing is performed after the shape detection processing. Thus, the processing program stored in the processing program storage area 42b of the internal RAM 42 has been rewritten from the processing program for the shape detection processing to the processing program for the denomination detection processing.

In this state, as shown in FIG. 8, the CPU core 41 of the high-speed CPU 31 in the detection processor 13a first performs processing to read the coordinate values of the initial point and end point in the main scan direction and the coordinate values of the initial point and end point in the sub scan direction that have been obtained by the shape detection processing, from the processing result storage area 42d of the internal RAM 42, in accordance with the processing program for the denomination detection processing stored in the processing program storage area 42b of the internal RAM 42 (step S31).

When the CPU core 41 of the high-speed CPU 31 has read the coordinate values of the initial point and end point in the main scan direction and the coordinate values of the initial point and end point in the sub scan direction in the image data, it performs denomination detection region deciding processing to decide a region of the image where a denomination is to be detected in the image of the paper presumed from the coordinate values (step S32). This denomination detection region deciding processing decides a region where a characteristic image for denomination detection is expected to exist, with regard to the region of the whole paper defined on the basis of the coordinate values of the initial point and end point in the main scan direction and the coordinate values of the initial point and end point in the sub scan direction as the detection results of the overall shape. In addition, results of the denomination detection region deciding processing are stored in the processing result storage area 42d of the internal RAM 42.

Following the denomination detection region deciding processing, the CPU core 41 of the high-speed CPU 31 performs sample pattern creation processing to create a sample pattern from an image of a denomination detection region as a processing result by the denomination detection region deciding processing, in accordance with the processing program for the denomination detection processing (step S33). Results of this sample pattern creation processing are also stored in the processing result storage area 42d of the internal RAM 42.

Following the sample pattern creation processing, the CPU core 41 of the high-speed CPU 31 performs processing for pattern matching wherein the sample pattern is matched with predetermined various patterns (standard patterns of denominations) for denomination identification (step S34). This matching processing calculates the degree of similarity between the sample pattern as a processing result of the sample pattern creation processing and the standard patterns of the predetermined denominations. Moreover, this matching processing determines that the paper in question is of the denomination having the highest similarity among the calculated degrees of similarity. In addition, results of this matching processing (information indicating the denomination of the paper) are also stored in the processing result storage area 42d of the internal RAM 42.

In the denomination detection processing achieved by one processing program as described above, a denomination is detected as an inspection result concerning one piece of paper, and the results are stored in the processing result storage area 42d of the internal RAM 42. Moreover, in the denomination detection processing, the denomination is judged with reference to the processing results of the shape detection processing described above.

Next, the magnetism detection processing will be described.

The magnetism detection processing is executed on the basis of magnetic information indicating the distribution of magnetism in the paper. Therefore, one of the sensor sections 11 comprises a magnetism detection sensor including a plurality of magnetic heads to detect the magnetism in the paper. For example, in the magnetic sensor as the sensor section 11, the magnetic heads are arranged in a direction perpendicular to the conveyance direction. In addition, in the magnetic information (information indicating the distribution of the magnetism in the paper) detected by the magnetism detection sensor as the sensor section 11, the direction perpendicular to the conveyance direction of the paper is defined as the main scan direction while the conveyance direction of the paper is defined as a sub scan direction, as in the case of the scanner as the sensor section 11.

Furthermore, the magnetism detection processing is executed after the shape detection processing and the denomination detection processing. Therefore, when the magnetism detection processing is executed, the processing results of the shape detection processing and the processing results of the denomination detection processing have been stored in the processing result storage area 42d of the internal RAM 42. Thus, the processing program to achieve the magnetism detection processing is programmed to properly refer to the processing results of the shape detection processing or the processing results of the denomination detection processing.

Furthermore, in the following explanation, the magnetic information detected by the magnetism detection sensor as the sensor section 11 has been stored in the sensor data storage area 42c of the internal RAM 42 in the detection processor 13a, in addition to the image data read by the scanner as the sensor section 11. Moreover, one processing program (processing program for the magnetism detection processing) to execute the magnetism detection processing described later has been loaded into the processing program storage area 42b of the internal RAM 42. Here, it is assumed that the magnetism detection processing is executed after the denomination detection processing. Thus, the processing program stored in the processing program storage area 42b of the internal RAM 42 has been rewritten from the processing program for the denomination detection processing to the processing program for the magnetism detection processing.

In this state, as shown in FIG. 9, the CPU core 41 of the high-speed CPU 31 in the detection processor 13a first performs processing to read the coordinate values of the initial point in the main scan direction and the coordinate values of the initial point in the sub scan direction that have been obtained by the shape detection processing from the processing result storage area 42d of the internal RAM 42, in accordance with the processing program for the magnetism detection processing stored in the processing program storage area 42b of the internal RAM 42 (step S41).

When the CPU core 41 of the high-speed CPU 31 has read the coordinate values of the initial point in the main scan direction and the coordinate values of the initial point in the sub scan direction that indicate the shape of the paper, it performs complete integration processing to completely integrate, for each channel, the magnetic information detected by the magnetic heads constituting the magnetism sensor as the sensor section 11, in accordance with the processing program for the magnetism detection processing (step S42). This complete integration processing for each channel detects a complete integration amount (quantity of magnetism) for each channel in the entire paper defined on the basis of the coordinate values of the initial point in the main scan direction and the coordinate values of the initial point in the sub scan direction as the results of the shape detection processing. In addition, results of the complete integration processing for each channel are stored in the processing result storage area 42d of the internal RAM 42.

Following the complete integration processing, the CPU core 41 of the high-speed CPU 31 performs partial integration processing to partially integrate, for each channel, the magnetic information detected by the magnetic heads constituting the magnetism sensor as the sensor section 11, in accordance with the processing program for the magnetism detection processing (step S43). This partial integration processing for each channel detects an integration amount (quantity of magnetism) of a particular part for each channel in the entire paper defined on the basis of the coordinate values of the initial point in the main scan direction and the coordinate values of the initial point in the sub scan direction as the results of the shape detection processing. In addition, results of the partial integration processing for each channel are stored in the processing result storage area 42d of the internal RAM 42.

Following the partial integration processing for each channel, the CPU core 41 of the high-speed CPU 31 performs comparison processing for each channel in accordance with the processing program for the magnetism detection processing (step S44). This comparison processing judges whether or not a characteristic as the magnetic information possessed by the paper has a characteristic as the magnetic information possessed by the denomination judged by the denomination detection processing on the basis of the processing results of the complete integration processing and the processing results of the partial integration processing. In addition, results of the comparison processing (information indicating whether or not the magnetic information on the paper is normal) are also stored in the processing result storage area 42d of the internal RAM 42.

In the magnetism detection processing achieved by one processing program as described above, a denomination is detected as an inspection result concerning one piece of paper, and the results are stored in the processing result storage area 42d of the internal RAM 42. Moreover, the magnetism detection processing judges whether or not the paper has the characteristic as the magnetic information on the denomination judged by the denomination detection processing, with reference to the processing results of the shape detection processing described above.

In such processing examples, the next processing is executed with reference to the processing results of the processing of the respective kinds. In such a case, in the inspection processing section of the present paper processing apparatus, each corresponding processing program is rewritten every processing program unit to the internal memory of the high-speed CPU for each kind of processing to be executed, and the preliminary processing results are also retained in the memory. Thus, the information detected by each sensor can be efficiently processed. Consequently, the present paper processing apparatus as a whole can achieve efficient processing of the paper.

Next, a second embodiment will be described.

In the second embodiment, there will be described a mail sorting apparatus (paper processing apparatus) having an address reading section (character recognition section) with a basic configuration similar to that of the inspection processing section described in the first embodiment.

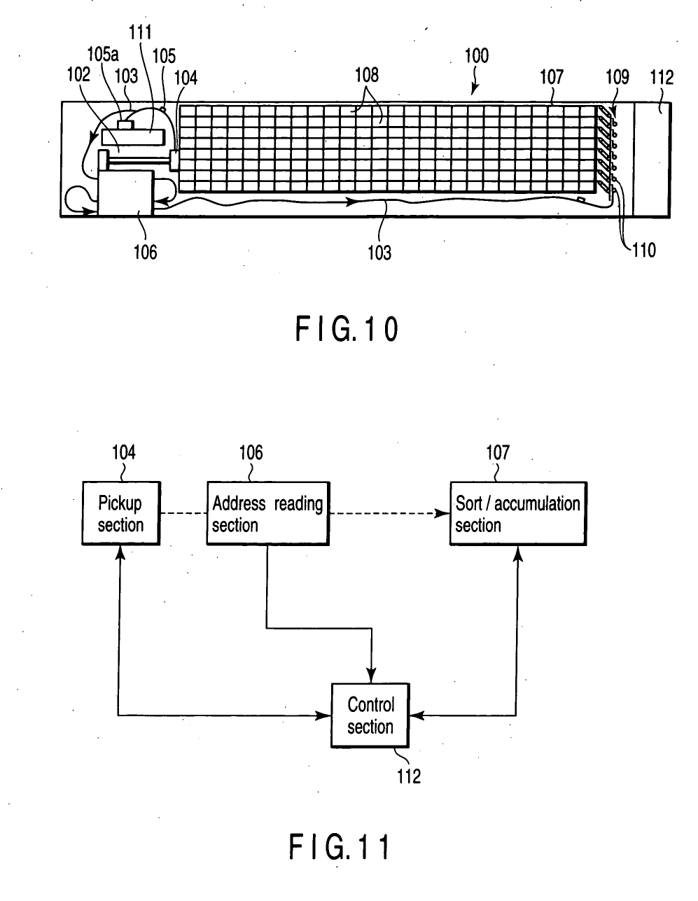

FIG. 10 is a diagram showing a schematic configuration example of a mail sorting apparatus 100 according to the second embodiment. Further, FIG. 11 is a diagram schematically showing the configuration of a control system in the mail sorting apparatus 100 shown in FIG. 10.

As shown in FIG. 10, the mail sorting apparatus 100 is provided with a supply section 102 which receives paper (mail) to be processed. In the paper (mail) received in the supply section 102, character information (postal code number, address, addressee, etc.) corresponding to address information is written on a first surface thereof. In the supply section 102, a plurality of pieces of mail is received upright with rear ends thereof aligned so that the first surfaces thereof are directed in the same direction. The supply section 102 sequentially supplies the received mail to a predetermined pickup position. In this pickup position for the mail, a pickup section 104 is disposed to pick up the mail received in the supply section 102 one by one along a main conveyance path 103. It is to be noted that the mail is disposed in the supply section 102 so that the postal code number is located on the upper side and the first surface is directed to the pickup section 104 when the mail is supplied to the pickup position.

The mail picked up by the pickup section 104 is conveyed via the main conveyance path 103 having a conveyance belt traveling at a fixed speed. On the main conveyance path 103, there is provided a foreign object/hardness detection section 105 which, when a foreign object is contained in the mail, detects the foreign object and detects the hardness of the mail itself. On a conveyance path diverging from the main conveyance path 103 downstream of the foreign object/hardness detection section 105, there is provided an elimination/accumulation section 105a to eliminate the mail which has been judged by the foreign object/hardness detection section 105 that it can not be mechanically processed.

On the main conveyance path 103 downstream of the foreign object/hardness detection section 105, there is provided an address reading section 106 which judges the address information written on the mail. The address reading section 106 reads an image on the first surface of the mail, recognizes the address information on the basis of the read image on the first surface of the mail, and determines a sort destination (a sort pocket 108 in a sort/accumulation section 107) of the mail on the basis of the recognized address information.

To a terminal end of the main conveyance path 103 downstream of the address reading section 106, there is connected the sort/accumulation section 107 (sort/accumulation means) which sorts the mail into the predetermined sort pockets (sort destinations) to accumulate the mail therein. It is to be noted that the sort destination means the position of the sort pocket in which the mail is sorted/accumulated. The sort/accumulation section 107 has a plurality of sort pockets 108 partitioned at a plurality of stages and in a plurality of lines. For example, 200 sort pockets 108 are configured with 8 stages and 25 lines. Sort gates (not shown) are provided over the sort pockets 108. These sort gates can be selectively switched to sort the mail into the predetermined sort pocket 108. It is to be noted that the sorting of the mail is controlled by a control section 112 described later on the basis of the result of judgment by the address reading section 106.

Furthermore, in the configuration example shown in FIG. 10, there is provided a plurality of switch gates 110 corresponding to stage path sections 109 of the sort/accumulation section 107, in the vicinity of the terminal end of the main conveyance path 103 directed to the sort/accumulation section 107. The switch gates 110 can be selectively switched to selectively connect the main conveyance path 103 to any one of the plurality of stages through each of the stage path sections 109.

Moreover, on a left front side in the drawing of the mail sorting apparatus 100, there is provided an operation panel 111 with which a person in charge performs various input operations. On a right side in the drawing of the mail sorting apparatus 100, there is provided the control section 112 which controls the sort operation of the mail sorting apparatus 100.

Next, the configuration of the address reading section 106 will be described.

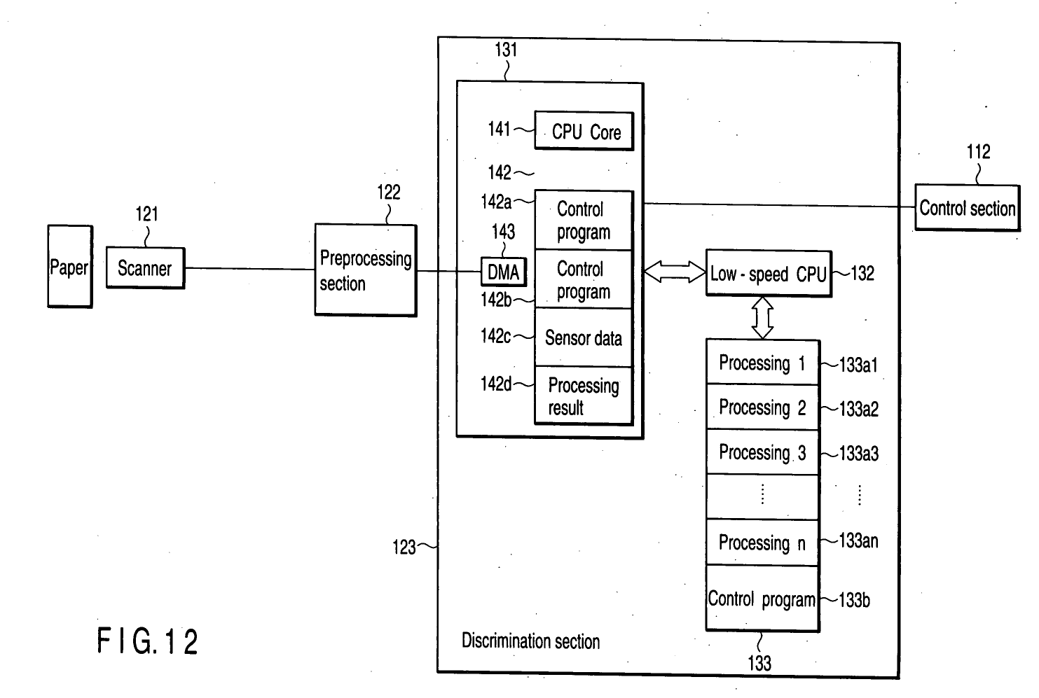

FIG. 12 is a diagram showing a configuration example of the address reading section 106.

The configuration example shown in FIG. 12 is analogous to the configuration of the inspection processing section 13 of the paper processing apparatus 1 described in the first embodiment.

The address reading section 106 has a scanner 121, a preprocessing section 122 and a discrimination section 123. The scanner 121 optically reads the image on the first surface of the mail, and converts it into image data. The scanner 121 comprises a CCD sensor, an A/D converter and the like. The CCD sensor optically scans the first surface of the mail on which the address information is written, and converts it into an electric signal. The electric signal as the image data read by the CCD sensor is supplied to the A/D converter. The A/D converter converts the image data from the CCD sensor into digital data such as bitmap data. The image data converted into the digital data by the A/D converter is supplied to the preprocessing section 122.

The preprocessing section 122 preprocesses the image data read by the scanner 121. The preprocessing section 122 performs preprocessing such as normalization of the image data supplied from the scanner 121. The preprocessing section 122 supplies the preprocessed image data to the discrimination section 123.

The discrimination section 123 recognizes the character information as the address information from the image on the first surface of the mail. The discrimination section 123 judges the sort destination of the mail on the basis of the recognized character information as the address information. The result of the judgment by the discrimination section 123 is supplied to the control section 112. It is to be noted that a plurality of discrimination sections 123 may be configured in such a manner as to be provided in the mail sorting apparatus 100. In this case, the image data on the mail read by the scanner 121 may be distributed to the respective discrimination sections 123.

The discrimination section 123 has a high-speed CPU 131, a low-speed CPU 132, an external ROM 133, etc., in the same manner as the detection processors 13a shown in FIG. 4.

The high-speed CPU 131 comprises a CPU core 141, an internal RAM 142, a direct memory access (DMA) 143, etc., in the same manner as the high-speed CPU 31 described above. The CPU core 141 is a processor which performs operation processing. The CPU core 141 performs the operation processing for the data stored in the internal RAM 142 on the basis of a program loaded into the internal RAM 142. Moreover, the CPU core 141 stores the results of the operation processing into the internal RAM 142.

The internal RAM 142 stores a program to be executed by the CPU core 141, and data. The internal RAM 142 is a memory which allows high-speed access by the CPU core 141. As shown in FIG. 12, the internal RAM 142 has a control program storage area 142a, a processing program storage area 142b, a sensor data storage area 142c, a processing result storage area 142d, etc.

It is to be noted that the control program storage area 142a, the processing program storage area 142b, the sensor data storage area 142c and the processing result storage area 142d shown in FIG. 12 have functions similar to those of the control program storage area 42a, the processing program storage area 42b, the sensor data storage area 42c and the processing result storage area 42d shown in FIG. 5. Therefore, they are not described in detail.

The low-speed CPU 132 operates in response to a request from the high-speed CPU 131. The low-speed CPU 132 controls access to the external ROM 133. The low-speed CPU 132 reads a processing program stored in the external ROM 133 on the basis of a processing program download request (request to rewrite the processing program) from the high-speed CPU 131, and outputs it to the high-speed CPU 131.

The external ROM 133 stores a control program and various processing programs to be downloaded to the high-speed CPU 131. In the configuration example shown in FIG. 12, the external ROM 133 has storage areas 133a1, 133a2, . . . , 133an to store the various processing programs, and a storage area 133b to store the control program. The processing programs stored in the storage areas 133a1, 133a2, . . . , 133an are programs which perform processing to obtain a particular inspection result on the basis of the sensor data.

For example, the processing programs stored in the storage areas 133a1, 133a2, . . . , 133an include a processing program for processing of detecting a region where characters are written (character region detection processing), a processing program for processing of detecting character lines (line detection processing), a processing program for processing of detecting individual characters (character detection processing), a processing program for processing of recognizing characters (character recognition processing), etc. Here, an algorithm including various instructions to perform processing for the acquisition of the particular inspection result is called the processing program. Moreover, the character region detection processing detects a region (character region) where the character information as the address information is written from the image data on the mail read by the scanner 121. The line detection processing detects the character information as the address information line by line from the character region in the image data read by the scanner 121. The character detection processing detects characters one by one from the detected character line. Further, in the character detection processing, each of the detected characters (character patterns) is normalized. The character recognition processing recognizes characters by a method of matching the detected character pattern for each character with a reference pattern in a dictionary. Moreover, in the character recognition processing, a word composed of the recognized characters may be compared with those in a dictionary in which words used as addresses are registered in order to recognize the address information.

Next, an operation example of the discrimination section 123 configured as above will be described.

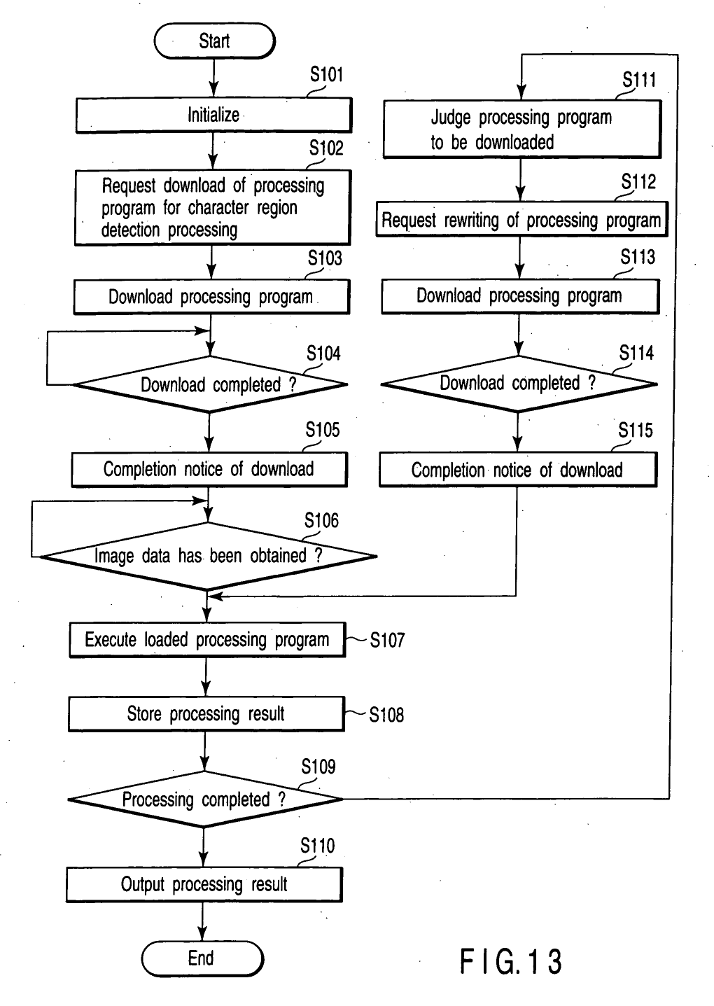

FIG. 13 is a flowchart to explain the operation example of the discrimination section 123. Here, the discrimination section 123 is supplied with, via the preprocessing section 122, image data on the mail read by the scanner 121. Thus, in the discrimination section 123, the image data on the mail read by the scanner 121 is stored as sensor data in the sensor data storage area 142c of the internal RAM 142.

First, the CPU core 141 of the high-speed CPU 131 performs processing to initialize the inside of the high-speed CPU 131 on the basis of the control program stored in the control program storage area 142a of the internal RAM 142 (step S101). In connection with this, the CPU core 141 of the high-speed CPU 131 outputs to the low-speed CPU 132 a download request indicating to download the processing program for the character region detection processing as first processing, as a processing program to be first downloaded in a series of processing (processing to determine a sort destination) to the processing program storage area 142b of the internal RAM 142 in accordance with the control program (step S102).

The low-speed CPU 132 which has received such a download request executes processing to download the processing program for the character region detection processing (processing to transfer the processing program) in response to the request from the high-speed CPU 131. That is, the low-speed CPU 132 which has received the download request selectively reads the processing program for the character region detection processing out of the processing programs stored in the external ROM 133. Once the low-speed CPU 132 reads the processing program, it downloads the processing program into the high-speed CPU 131.

When the requested download of the processing program for the character region detection is started by the low-speed CPU 132, the high-speed CPU 131 stores the transferred (downloaded) processing program into the processing program storage area 142b of the internal RAM 142 (step S103).

When the whole processing program for the character region detection processing downloaded by the low-speed CPU 132 is stored in the processing program storage area 142b of the internal RAM 142, that is, when the download of the processing program from the low-speed CPU 132 is completed (step S104, YES), the CPU core 141 of the high-speed CPU 131 outputs to the low-speed CPU 132 a download completion notice indicating that the download is completed (step S105).

Furthermore, when the download of the processing program for the character region detection processing is completed, the CPU core 141 of the high-speed CPU 131 judges whether or not the image data on the mail to be processed has been obtained (step S106). This judgment is made to see whether or not the image data on the mail read by the scanner 121 is stored in the sensor data storage area 142c of the internal RAM 142.

When the above judgment is that the image data to be processed has been obtained (step S106, YES), the CPU core 141 of the high-speed CPU 131 performs the processing program stored in the processing program storage area 142b of the internal RAM 142 (step S107). Here, the processing program for the character region detection processing is stored in the processing program storage area 142b. Thus, the CPU core 141 executes the processing to detect the character region from the image data stored in the sensor data storage area 142c. Moreover, the CPU core 141 of the high-speed CPU 131 stores the result (processing result) of executing the processing program for the character region detection processing stored in the processing program storage area 142b of the internal RAM 142 into the processing result storage area 142d of the internal RAM 142 (step S108).

When the processing performed with the processing program loaded in the processing program storage area 142b of the internal RAM 142 is completed, the CPU core 141 of the high-speed CPU 131 judges whether or not the whole series of processing (the processing by all the processing programs to be executed) has been completed (step S109). This judgment is made to see whether or not the processing by all the processing programs to be executed for the image data on the mail stored in the sensor data storage area 142c of the internal RAM 142 has been completed. In other words, the above judgment is made to see whether or not there exists a processing program to be subsequently executed.

When the above judgment is that the whole series of processing has been completed (step S109, YES), the CPU core 141 of the high-speed CPU 131 outputs, to the control section 112, information in which the identification information (information to identify mail) is assigned to the processing result stored in the processing result storage area 142d of the internal RAM 142.

Furthermore, if the above judgment is that the whole series of processing is not completed, that is, if the above judgment is that there exists a processing program to be subsequently executed (step S109, NO), the CPU core 141 of the high-speed CPU 131 judges the processing program to be downloaded next (step S111). This is achieved to judge each program including at least a plurality of instruction units as a processing program to be downloaded. Here, one processing program to be downloaded is judged every processing program unit corresponding to each process.

In addition, as in the first embodiment described above, when one processing program corresponding to one process has a data size that can not be contained in the processing program storage area 142b of the internal RAM 142, the CPU core 141 may judge each program divided from one processing program corresponding to one process as a processing program to be downloaded in one download process. Moreover, when a plurality of processing programs corresponding to a plurality of processes has a data size that can be contained in the processing program storage area 142b of the internal RAM 142, the CPU core 141 may judge the plurality of processing programs corresponding to the plurality of processes as processing programs to be downloaded in one download process.

When a processing program to be downloaded is determined in the judgment, the CPU core 141 of the high-speed CPU 131 outputs a download request to request the download of the processing program (request for the rewriting of the processing program) to the low-speed CPU 132 (step 112).

The low-speed CPU 132 which has received such a download request executes processing to download the processing program (processing to transfer the processing program) corresponding to the request from the high-speed CPU 131. That is, the low-speed CPU 132 which has received the download request selectively reads the processing program that is requested by the high-speed CPU 131 to be downloaded out of the processing programs stored in the external ROM 133. Once the low-speed CPU 132 reads the processing program, it downloads the processing program into the high-speed CPU 131.

When the requested download of the processing program is started by the low-speed CPU 132, the high-speed CPU 131 stores the transferred (downloaded) processing program into the processing program storage area 142b of the internal RAM 142 (step S113). At this moment, data (executed processing programs) stored in the processing program storage area 142b of the internal RAM 142 are erased. That is, in step S113, the processing programs stored in the processing program storage area 142b of the internal RAM 142 are rewritten.

When the whole processing program downloaded by the low-speed CPU 132 is stored in the processing program storage area 142b of the internal RAM 142, that is, when the download of the processing program from the low-speed CPU 132 is completed (step S114, YES), the CPU core 141 of the high-speed CPU 131 outputs to the low-speed CPU 132 a download completion notice indicating that the download is completed (step S115).

When the whole processing program downloaded by the low-speed CPU 132 is stored in the processing program storage area 142b of the internal RAM 142, that is, when the download of the processing program from the low-speed CPU 132 is completed (step S114, YES), the CPU core 141 of the high-speed CPU 131 outputs to the low-speed CPU 132 a download completion notice indicating that the download is completed (step S115).

Furthermore, when the download of the processing program is completed, the CPU core 141 of the high-speed CPU 131 executes, as in step S107 above, the processing program stored in the processing program storage area 42b of the internal RAM 142 (step S107). In this case, the CPU core 141 of the high-speed CPU 131 executes the processing program stored in the processing program storage area 142b with reference to the processing results obtained in preliminary processing as well. For example, when the character line detection processing is performed as second processing, this processing program detects a character line with reference to a processing result (information indicating a character region) of character region detection processing as first processing stored in the processing result storage area 142d.

Moreover, the CPU core 141 of the high-speed CPU 131, as in step S108 above, stores the result (processing result) of executing the processing program stored in the processing program storage area 142b of the internal RAM 142 into the processing result storage area 142d of the internal RAM 142 (step S108).

When the processing performed with the processing program stored in the processing program storage area 142b of the internal RAM 142 is completed, the CPU core 141 of the high-speed CPU 131 judges whether or not the whole series of processing (the processing by all the processing programs to be executed) has been completed (step S109). When the above judgment is that the whole series of processing has been completed (step S109, YES), the CPU core 141 of the high-speed CPU 131 outputs, to the control section 112, information in which the identification information is assigned to the processing result stored in the processing result storage area 142d of the internal RAM 142.

Furthermore, if the above judgment is that the whole series of processing is not completed, that is, if the above judgment is that there exists a processing program to be subsequently executed (step S109, NO), the CPU core 141 of the high-speed CPU 131 returns to step S111, and again performs the processing of steps S111 to S115 and S107 to S108. In this case, the high-speed CPU 131 rewrites the processing program stored in the processing program storage area 142b of the internal RAM 142 to the next processing program, and performs the processing in accordance with the next processing program.

In the mail sorting apparatus 100, a plurality of processing programs corresponding to various kinds of processing executed as sort destination determination processing for the high-speed CPU 131 to determine the sort destination is loaded from an external memory into the internal RAM inside the high-speed CPU every processing program unit. This makes it possible to improve the processing speed in the whole sort destination determination processing. As a result, it is further possible to achieve more efficient processing of paper in the mail sorting apparatus 100.

For example, as effects according to the first and second embodiments described above, in a case where a processing program processed by the high-speed CPU at 5 msec is stored in the internal memory inside the high-speed CPU, a processing time of about 10 msec is required if the high-speed CPU reads the processing program stored in the external memory in instruction units and processes the processing program. Moreover, if the time required to rewrite the processing program in the internal memory inside the high-speed CPU is several μsec, an apparatus which loads the processing program in the external memory in the instruction units and processes the processing program requires a processing time of about 35 msec for a series of processing including a plurality of processing programs performed by the paper processing apparatus 1 or the mail sorting apparatus 100 at about 20 msec.

As described above, in the paper processing apparatus described in the first embodiment or the mail sorting apparatus described in the second embodiment, it is possible to restrain processing efficiency from decreasing due to the execution of various processing programs to process paper. As a result, paper can be efficiently processed in the paper processing apparatus or the mail sorting apparatus described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A paper processing apparatus which processes paper, comprising:
a sensor which detects information including a characteristic amount of the paper to be processed;
a external memory which stores various processing programs including a plurality of instructions to process the information detected by the sensor;
a first processor which selectively loads the various processing programs stored in the external memory every processing program unit;
a second processor which executes the processing program selectively loaded into a internal memory by the first processor; and
a processing section which processes the paper on the basis of processing results of the processing program executed by the second processor.

2. The paper processing apparatus according to claim 1, wherein
the second processor has:
a internal memory having a first storage area which stores the information detected by the sensor, and a second storage area which stores the processing program selectively loaded by the first processor; and
an operation section which executes the processing program stored in the second storage area of the internal memory to process the information stored in the first storage area and detected by the sensor.

3. The paper processing apparatus according to claim 2, wherein
the internal memory further has a third storage area which stores processing results executed by the operation section, and
the operation section executes the processing program stored in the second storage area of the internal memory with reference to the processing results stored in the third storage area of the internal memory in order to process the information stored in the first storage area of the internal memory and detected by the sensor.

4. The paper processing apparatus according to claim 2, wherein
the second processor requests a desired processing program from the first processor in accordance with a processing condition of the information detected by the sensor, and
the first processor loads the processing program stored in the external memory into the second processor in response to the request from the second processor.

5. The paper processing apparatus according to claim 4, wherein
the external memory stores a series of a plurality of processing programs to obtain information necessary for the processing section to process the paper, and
the second processor requests a next processing program from the first processor whenever the processing program loaded into the internal memory terminates, and rewrites the processing program stored in the second storage area of the internal memory to the processing program loaded from the first processor in response to the request.

6. A paper processing apparatus comprising: a conveyance section which conveys paper; a sensor which detects information including a characteristic amount from the paper conveyed by the conveyance section; an inspection section which inspects the paper on the basis of the information detected by the sensor; and a sort processing section which sorts the paper conveyed by the conveyance section in accordance with an inspection result by the inspection section,
wherein the inspection section has:
a external memory which stores various processing programs including a plurality of instructions to obtain the inspection result used for sorting the paper on the basis of the information detected by the sensor;
a first processor which selectively loads the various processing programs stored in the external memory every processing program unit; and
a second processor which executes the processing program selectively loaded into a internal memory by the first processor.

7. The paper processing apparatus according to claim 6, wherein
the second processor has:
a internal memory having a first storage area which stores the information detected by the sensor, and a second storage area which stores the processing program selectively loaded by the first processor; and
an operation section which executes the processing program stored in the second storage area of the internal memory to process the information stored in the first storage area and detected by the sensor.

8. The paper processing apparatus according to claim 7, wherein
the internal memory further has a third storage area which stores processing results executed by the operation section, and
the operation section executes the processing program stored in the second storage area of the internal memory with reference to the processing results stored in the third storage area of the internal memory in order to process the information stored in the first storage area and detected by the sensor.

9. The paper processing apparatus according to claim 7, wherein
the second processor requests a desired processing program from the first processor in accordance with a processing condition of the information detected by the sensor, and
the first processor loads the processing program stored in the external memory into the second processor in response to the request from the second processor.

10. The paper processing apparatus according to claim 9, wherein
the external memory stores a series of a plurality of processing programs to obtain information necessary for the processing section to process the paper, and
the second processor requests a next processing program from the first processor whenever the processing program loaded in the internal memory terminates, and rewrites the processing program stored in the second storage area of the internal memory to the processing program loaded from the first processor in response to the request.

11. A paper processing method of processing paper, comprising:
detecting information including a characteristic amount from the paper to be processed;
selectively loading a processing program from a external memory storing various processing programs including a plurality of instructions to obtain information to process the paper from the information including the characteristic amount detected from the paper to be processed;
executing the processing program selectively loaded into a internal memory; and
processing the paper on the basis of processing results of the processing program.

12. The paper processing method according to claim 11, further comprising:
storing the information including the characteristic amount detected from the paper to be processed in a first storage area of the internal memory; and
storing the processing program selectively loaded in a second storage area of the internal memory,
wherein executing the processing program is executing the processing program stored in the second storage area of the internal memory, with reference to the information including the characteristic amount stored in the first storage area of the internal memory and detected from the paper to be processed.

13. The paper processing method according to claim 12, further comprising:
storing processing results by the executed processing program in a third storage area of the internal memory,
wherein in executing the processing program is executing the processing program stored in the second storage area of the internal memory, with reference to the information including the characteristic amount stored in the first storage area of the internal memory and detected from the paper to be processed, and the processing results stored in the third storage area of the internal memory.

14. The paper processing method according to claim 12, wherein
selectively loading the processing program from the external memory is loading, from the external memory, a processing program corresponding to a processing condition of the information including the characteristic amount detected from the paper to be processed.

15. The paper processing method according to claim 14, wherein
the external memory stores a series of a plurality of processing programs to obtain information necessary to process the paper,
selectively loading the processing program from the external memory is loading a next processing program whenever the processing program loaded into the second storage area of the internal memory terminates, and
storing the processing program stored in the second storage area of the internal memory is rewriting the processing program stored in the second storage area of the internal memory to the loaded processing program.
